(19) United States
(12) Patent Application Publication
(10) Pub. No.: US 2017/0353955 A1
(43) Pub. Date: Dec. 7, 2017

(54) RESOURCE MANAGEMENT

(71) Applicant: QUALCOMM Incorporated, San Diego, CA (US)

(72) Inventors: Chih-Ping Hsu, San Diego, CA (US); Tarandeep Virk, San Diego, CA (US); Robert Chan, La Jolla, CA (US); Xiaohu Zhang, San Diego, CA (US)

(21) Appl. No.: 15/170,803

(22) Filed: Jun. 1, 2016

(51) Int. Cl. H04W 72/04; H04B 7/06

(52) U.S. Cl. CPC H04W 72/0453; H04B 7/0602

(57) ABSTRACT

Methods, systems, and devices for wireless communication are described. A user equipment (UE) may perform uplink communications on a first radio frequency spectrum band using a first transceiver and a first antenna. The first transceiver may have a first capability configuration. The UE may receive an assignment for uplink communications on a second radio frequency spectrum band and couple a second transceiver to the first antenna to perform the uplink communications on the first radio frequency spectrum band. The spectrum transceiver may have a second capability configuration that is different from the first capability configuration with respect to at least the second radio frequency spectrum band. The UE may switch the first transceiver to a second antenna for the uplink communications on the second radio frequency spectrum band.

### BACKGROUND

The following relates generally to wireless communication, and more specifically to improved resource management.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include code division multiple access (CDMA) systems, time division multiple access (TDMA) systems, frequency division multiple access (FDMA) systems, and orthogonal frequency division multiple access (OFDMA) systems, (e.g., a Long Term Evolution (LTE) system). A wireless multiple-access communications system may include a number of base stations, each simultaneously supporting communication for multiple communication devices, which may be otherwise known as user equipment (UE).

Wireless communications systems may support carrier aggregation (CA) techniques that include communications using more than one carrier. The number of aggregated carriers may be different in downlink (DL) and uplink (UL) communications. The aggregated carriers may be arranged in a number of ways, e.g., based on contiguous component carriers within the same operating frequency band and/or based on non-contiguous allocations, where the component carriers may be either be intra-band, or inter-band. The CA configuration may be dynamically configured and may include the UE adding the additional component carrier assigned by the network, e.g., by the current serving base station. This sudden reconfiguration, e.g., the adding of an additional component carrier, may be problematic when the UE is already engaged in ongoing communications. Improved methods of communication between the base station and the UE are desired.

### SUMMARY

The described techniques relate to improved methods, systems, devices, or apparatuses that support improved resource management. Generally, the described techniques provide for a user equipment (UE) that includes at least two transceivers and two antennas. In some aspects, at least one transceiver may be a primary transceiver, e.g., used for voice/data communications. In some examples, the primary transceiver may have a capability configuration that is different from the capability configuration of the second transceiver, e.g., may communicate in more, different, or preferred frequency bands. The primary transceiver may be coupled to a particular antenna based on various antenna selection schemes supported by the UE, e.g., based on measured antenna performance that may consider interference levels of the different UE antennas. Thus, the primary transceiver and selected antenna may be coupled and perform communications on a radio frequency spectrum band, e.g., uplink (UL) and/or downlink (DL) communications. The UE may receive an assignment for uplink communications on a second radio frequency spectrum band, e.g., for carrier aggregation (CA) UL communications. The UE may couple a second transceiver to the selected antenna to perform the communications on the first radio frequency spectrum band. The UE may couple the primary transceiver to a second antenna of the UE to perform the communications on the second radio frequency spectrum band. Coupling the second transceiver to the selected antenna may reduce and/or eliminate, in some examples, any differences between the UL signal transmitted using the primary transceiver and the second transceiver. This may improve and/or maintain link performance between the UE and a base station(s).

A method of wireless communication is described. The method may include performing uplink communications on a first radio frequency spectrum band using a first transceiver and a first antenna, the first transceiver having a first capability configuration, receiving an assignment for uplink communications on a second radio frequency spectrum band, coupling a second transceiver to the first antenna so as to perform the uplink communications on the first radio frequency spectrum band using the second transceiver and the first antenna, the second transceiver having a second capability configuration that is different from the first capability configuration with respect to at least the second radio frequency spectrum band, and switching the first transceiver to a second antenna for the uplink communications on the second radio frequency spectrum band.

An apparatus for wireless communication is described. The apparatus may include means for performing uplink communications on a first radio frequency spectrum band using a first transceiver and a first antenna, the first transceiver having a first capability configuration, means for receiving an assignment for uplink communications on a second radio frequency spectrum band, means for coupling a second transceiver to the first antenna so as to perform the uplink communications on the first radio frequency spectrum band using the second transceiver and the first antenna, the second transceiver having a second capability configuration that is different from the first capability configuration with respect to at least the second radio frequency spectrum band, and means for switching the first transceiver to a second antenna for the uplink communications on the second radio frequency spectrum band.

A further apparatus for wireless communication is described. The apparatus may include a processor, memory in electronic communication with the processor, and instructions stored in the memory. The instructions may be operable to cause the processor to perform uplink communications on a first radio frequency spectrum band using a first transceiver and a first antenna, the first transceiver having a first capability configuration, receive an assignment for uplink communications on a second radio frequency spectrum band, couple a second transceiver to the first antenna so as to perform the uplink communications on the first radio frequency spectrum band using the second transceiver and the first antenna, the second transceiver having a second capability configuration that is different from the first capability configuration with respect to at least the second radio frequency spectrum band, and switch the first transceiver to a second antenna for the uplink communications on the second radio frequency spectrum band.

A non-transitory computer readable medium for wireless communication is described. The non-transitory computer-readable medium may include instructions operable to cause a processor to perform uplink communications on a first radio frequency spectrum band using a first transceiver and a first antenna, the first transceiver having a first capability configuration, receive an assignment for uplink communications on a second radio frequency spectrum band, couple a second transceiver to the first antenna so as to perform the uplink communications on the first radio frequency spectrum band using the second transceiver and the first antenna, the second transceiver having a second capability configuration that is different from the first capability configuration with respect to at least the second radio frequency spectrum band, and switch the first transceiver to a second antenna for the uplink communications on the second radio frequency spectrum band.

In some examples of the method, apparatus, or non-transitory computer-readable medium described above, at least one of coupling the second transceiver to the first antenna comprises: using an antenna switch diversity function to couple the second transceiver to the first antenna, or switching the first transceiver to the second antenna including using an antenna switch diversity function to switch the first transceiver to the second antenna. In some examples of the method, apparatus, or non-transitory computer-readable medium described above, coupling the second transceiver to the first antenna comprises: maintaining a propagation characteristic of the uplink communications on the first radio frequency spectrum band to within a predefined range.

In some examples of the method, apparatus, or non-transitory computer-readable medium described above, coupling the second transceiver to the first antenna comprises: coupling the second transceiver to the first antenna during an active session of the uplink communications on the first radio frequency spectrum band.

Some examples of the method, apparatus, or non-transitory computer-readable medium described above may further include processes, features, means, or instructions for identifying a difference between the first capability configuration and the second capability configuration. Some examples of the method, apparatus, or non-transitory computer-readable medium described above may further include processes, features, means, or instructions for adjusting at least one parameter associated with the second transceiver based at least in part on the difference.

In some examples of the method, apparatus, or non-transitory computer-readable medium described above, the at least one parameter comprises at least one of an output power of the second transceiver, an output frequency of the second transceiver, an output timing parameter of the second transceiver, or an output data rate of the second transceiver. In some examples of the method, apparatus, or non-transitory computer-readable medium described above, adjusting the at least one parameter comprises: adjusting the at least one parameter of the second transceiver to provide an input to the first antenna that is substantially the same as an input to the first antenna provided by the first transceiver.

In some examples of the method, apparatus, or non-transitory computer-readable medium described above, the second capability configuration does not support uplink communications on the second radio frequency spectrum band. In some examples of the method, apparatus, or non-transitory computer-readable medium described above, the first capability configuration supports uplink communications on the first radio frequency spectrum band and the second radio frequency spectrum band. In some examples of the method, apparatus, or non-transitory computer-readable medium described above, the uplink communications on the first radio frequency spectrum band and the second radio frequency spectrum band comprise uplink carrier aggregation communications.

Some examples of the method, apparatus, or non-transitory computer-readable medium described above may further include processes, features, means, or instructions for employing the first antenna as a primary receive antenna for the first radio frequency spectrum band and the second antenna as a diversity receive antenna for the first radio frequency spectrum band before coupling the second transceiver to the first antenna and switching the first transceiver to the second antenna. Some examples of the method, apparatus, or non-transitory computer-readable medium described above may further include processes, features, means, or instructions for employing the first antenna as a primary receive antenna for the first radio frequency spectrum band and the second antenna as a diversity receive antenna for the first radio frequency spectrum band after coupling the second transceiver to the first antenna and switching the first transceiver to the second antenna.

Some examples of the method, apparatus, or non-transitory computer-readable medium described above may further include processes, features, means, or instructions for employing the first antenna and the first transceiver as a primary communication chain when uplink communications on the first radio frequency spectrum band are used.

### BRIEF DESCRIPTION OF THE DRAWINGS

FIG. 1 illustrates an example of a wireless communications system that supports improved resource management in accordance with aspects of the present disclosure.

FIG. 2 illustrates an example of a device that supports improved resource management in accordance with aspects of the present disclosure.

FIG. 3 illustrates an example of a block diagram showing aspects of a device that supports improved resource management in accordance with aspects of the present disclosure.

FIG. 4 illustrates an example of a block diagram showing aspects of a device that supports improved resource management in accordance with aspects of the present disclosure.

FIGS. 5 through 7 show block diagrams of a wireless device that supports improved resource management in accordance with aspects of the present disclosure.

FIG. 8 illustrates a block diagram of a system including a user equipment (UE) that supports improved resource management in accordance with aspects of the present disclosure.

FIGS. 9 through 11 illustrate methods for improved resource management in accordance with aspects of the present disclosure.

### DETAILED DESCRIPTION

Wireless communication systems may support inter-band uplink carrier aggregation (CA) communications. In some designs, the transmission of two different component carriers (e.g., frequencies) using a same antenna may not be desirable and, instead, different antennas may be used for the different frequency transmissions. Moreover, uplink CA may not always be configured by the network and, when not configured, the radio frequency (RF) design of a user equipment (UE) may give preference to a particular transceiver and antenna. In some RF designs, the two transceivers of a UE may not have the same capability configuration. Thus, when uplink CA is assigned, enabled, and/or stopped, the UE may change the transceiver/antenna pair being used for communications. However, changing the transceiver/antenna pair may cause discontinuity of the transmit and/or receive signals and degrade performance of the UE, base station, and/or communication link.

Aspects of the disclosure are initially described in the context of a wireless communication system. For example, a UE may support improved resource management to mitigate the discontinuity associated with changing the transceiver/antenna pair. For example, the UE may use a first transceiver and a first antenna to perform uplink communications on a first radio frequency spectrum band. The UE may receive an assignment for uplink communications on a second radio frequency spectrum band. The UE may couple a second transceiver to the first antenna to perform the uplink communications on the first radio frequency spectrum band and couple the first transceiver to a second antenna to perform the uplink communications on the second radio frequency spectrum band. The first and second transceivers may have different capability configurations, e.g., the second transceiver may not support communicating on the second radio frequency spectrum band. Coupling the second transceiver to the first antenna (e.g., maintaining the first antenna) for the uplink communications on the first radio frequency spectrum band may reduce and/or eliminate, in some examples, any discontinuity for the uplink communications on the first radio frequency spectrum band.

Aspects of the disclosure are further illustrated by and described with reference to apparatus diagrams, system diagrams, and flowcharts that relate to title of the application.

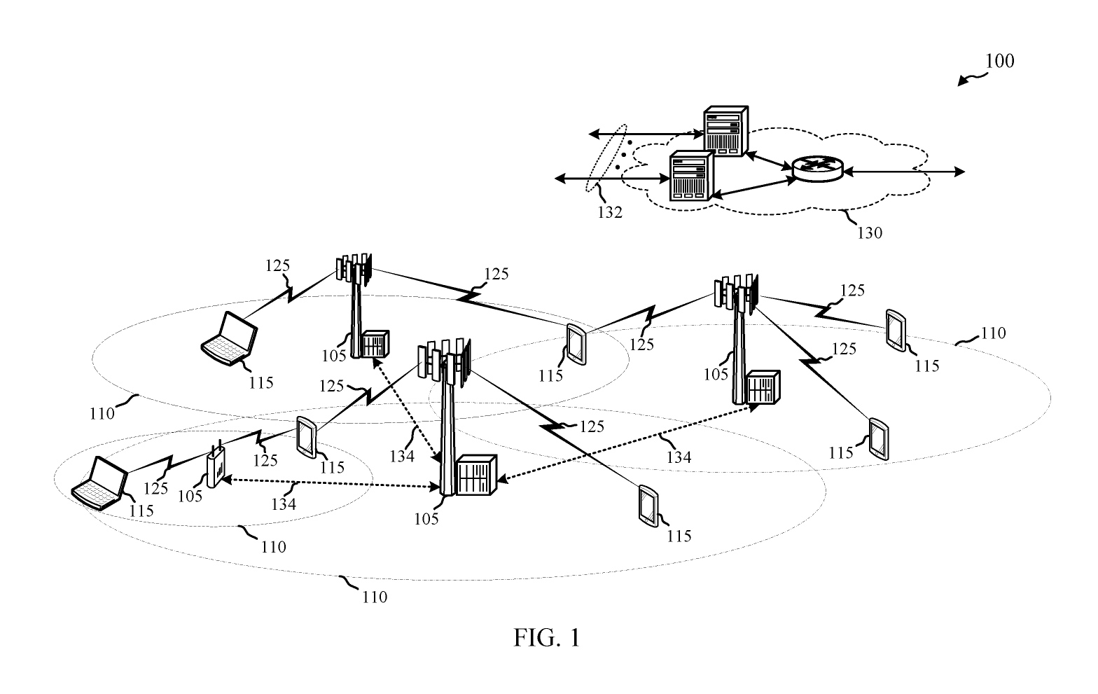

FIG. 1 illustrates an example of a wireless communications system 100 in accordance with various aspects of the present disclosure. The wireless communications system 100 includes base stations 105, user equipment (UE)s 115, and a core network 130. In some examples, the wireless communications system 100 may be a Long Term Evolution (LTE) (e.g., or LTE-Advanced) network. Wireless communications system 100 may support various aspects of the described resource management improvement techniques.

Base stations 105 may wirelessly communicate with UEs 115 (e.g., using various radio access technologies (RATs) or wireless technologies) via one or more base station antennas. Each base station 105 may provide communication coverage for a respective geographic coverage area 110. Each base station 105 may provide communication coverage for a macro cell, a small cell, or other types of cell. The term “cell” is a 3rd Generation Partnership Project “3GPP” term that can be used to describe a base station, a carrier or component carrier associated with a base station, or a coverage area (e.g., sector, etc.) of a carrier or base station, depending on context. Communication links 125 shown in wireless communications system 100 may include uplink (UL) transmissions from a UE 115 to a base station 105, or downlink (DL) transmissions, from a base station 105 to a UE 115. UEs 115 may be dispersed throughout the wireless communications system 100, and each UE 115 may be stationary or mobile. A UE 115 may also be referred to as a mobile station, a subscriber station, a remote unit, a wireless device, an access terminal (AT), a handset, a user agent, a client, wireless communication UE apparatus, or like terminology. A UE 115 may also be a cellular phone, a wireless modem, a handheld device, a personal computer, a tablet, a personal electronic device, an machine type communication (MTC) device, etc.

Base stations 105 may communicate with the core network 130 and with one another. For example, base stations 105 may interface with the core network 130 through backhaul links 132 (e.g., S1, etc.). Base stations 105 may communicate with one another over backhaul links 134 (e.g., X2, etc.) either directly or indirectly (e.g., through core network 130). Base stations 105 may perform radio configuration and scheduling for communication with UEs 115, or may operate under the control of a base station controller (not shown). In some examples, base stations 105 may be macro cells, small cells, hot spots, or the like. A base station 105 may also be referred to as an access point (“AP”), a Node B, Radio Network Controller (“RNC”), evolved Node B (eNB), Base Station Controller (“BSC”), Base Transceiver Station (“BTS”), Base Station (“BS”), Transceiver Function (“TF”), Radio Router, Radio Transceiver, Basic Service Set (“BSS”), Extended Service Set (“ESS”), Radio Base Station (“RBS”), or some other terminology.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include code division multiple access (CDMA) systems, time division multiple access (TDMA) systems, frequency division multiple access (FDMA) systems, and orthogonal frequency division multiple access (OFDMA) systems. A wireless multiple-access communications system may include a number of base stations 105, each simultaneously supporting communication for one or more multiple communication devices, which may be otherwise known as a UE 115.

In some cases, a base station 105 and a UE 115 may communicate using more than one carrier. Each aggregated carrier is referred to as a component carrier (CC). Each component can have a bandwidth of, e.g., 1.4, 3, 5, 10, 15 or 20 MHz. In some cases, the number of CCs can be limited to, e.g., a maximum of five giving maximum aggregated bandwidth is 100 MHz. In frequency division duplexing (FDD), the number of aggregated carriers can be different in DL and UL. The number of UL component carriers may be equal to or lower than the number of DL component carriers. The individual component carriers can also be of different bandwidths. For time division duplexing (TDD) the number of CCs as well as the bandwidths of each CC will normally be the same for DL and UL. Component carriers may be arranged in a number of ways. For example, a CA configuration may be based on contiguous component carriers within the same operating frequency band, e.g., called intra-band contiguous CA. Non-contiguous allocations can also be used, where the component carriers may be either be intra-band, or inter-band.

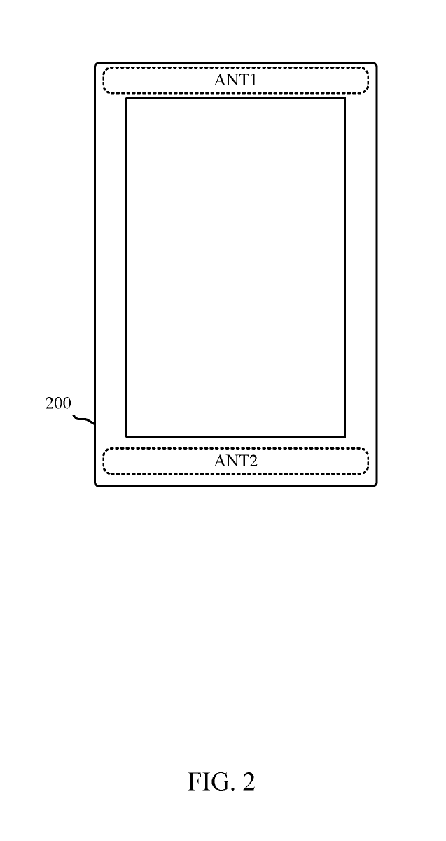

UE(s) 115 of wireless communications system 100 may support improved resource management techniques, such as is described with reference to FIGS. 2 through 4. For example a UE 115 may reduce and/or eliminate, in some examples, discontinuity associated with switching a transceiver/antenna pair during uplink communications. The UE 115 may be performing uplink communications on a first radio frequency spectrum band using a first transceiver and a first antenna. The UE 115 may receive an assignment for uplink communications on a second radio frequency spectrum band and couple a second transceiver to the first antenna to perform the uplink communications on the first radio frequency spectrum band. Using the second transceiver and the first antenna to perform the uplink communications on the first radio frequency spectrum band may maintain the uplink transmission characteristics to within a predefined range that helps to ensure link connectivity between the UE 115 and a base station 105. The UE 115 may switch or otherwise couple the first transceiver to a second antenna to perform the uplink communications on the second radio frequency spectrum band. The first and second transceivers may have different capability configurations, e.g., the second transceiver may not support communications on the second radio frequency spectrum band. The UE 115 may, in some examples, identify other differences between the first and second transceivers and adjust parameter(s) associated with the second transceiver to provide an input to the first antenna that is the same (e.g., or within a predefined range) as the input being provided by the first transceiver.

FIG. 2 illustrates an example of a device 200 for improved resource management, in accordance with various aspects of the present disclosure. In some cases, device 200 may represent aspects of techniques performed by a UE 115, as described with reference to FIG. 1. Device 200 may support the described resource management improvement techniques and maintain link continuity when switching transceiver/antenna pairs during uplink communications on a radio frequency spectrum band.

Device 200 may include two antennas, illustrated as ANT1 and ANT2 for ease of reference, that are positioned on the top and bottom, respectively, of device 200. It is to be understood, however, that device 200 may include more than two antennas and/or that the antennas may be positioned at different locations on device 200. Locating the antennas at different locations on the device 200 may provide transmit diversity by enabling communication (e.g., transmission) of signals on different propagation paths. Each antenna may therefore have different communication (e.g., transmission) characteristics at any given time based on different interference contributors. For example, a user may hold the device 200 in different manners during normal use and, when being held, the user's hand may introduce interference to one antenna by blocking the antenna. Another antenna, however, may not be blocked and therefore may have better transmission performance than the blocked antenna. Other examples of interference contributors may include, but are not limited to, nearby obstructions, objects, etc.

Device 200 may monitor and identify the interference associated with each antenna using various performance measurement techniques, e.g., path loss measurements. For example, the device 200 may measure signal levels, data errors, etc., using transmit and/or receive signals on each antenna and determine the amount of interference each antenna is experiencing.

Device 200 may also include two transceivers, which may also be referred to as communication chains, transmit/receive chains, etc. Each transceiver may be configured differently and therefore may support different communications on the same or different radio frequency spectrum bands. For example, a first transceiver may be configured to communicate on more than one radio frequency spectrum band (e.g., F1 and F2). The second transceiver may be configured to communicate on one radio frequency spectrum band (e.g., F1). Thus, each transceiver may have a capability configuration, which is different between the transceivers. Each transceiver may also have other differences, e.g., transmit power outputs, output frequency characteristics, different timing parameters, supported data rates, etc. In some examples, device 200 may have a primary or preferred transceiver, e.g., the primary transceiver may communicate on more radio frequency spectrum bands, may support higher transmit power, etc. Thus, device 200 may use or employ the primary transceiver for communications and use the second or secondary transceiver for channel monitoring functions and/or may power the second transceiver down to conserve power.

In some aspects, device 200 may use an antenna switch diversity function to select or otherwise route communications to a particular antenna, e.g., from the primary transceiver to the first antenna. The antenna switch diversity function may be coupled to each transceiver, either directly or through various amplifiers, filters, etc., and also to each antenna of device 200. For example, the antenna switch diversity function may couple or otherwise switch the primary transceiver to a first antenna for communications on a radio frequency spectrum band.

In some aspects, the device 200 may configure the antenna switch diversity to couple the first transceiver to the first antenna for uplink communications on a first radio frequency spectrum band (e.g., F1). The communications on F1 may be between device 200 and a base station and/or a UE, such as is described with reference to FIG. 1. The communications on F1 may be an active session of uplink and/or downlink communications on F1 between device 200 and the base station. In some examples, an active communication session may include the base station being in a tracking mode. The tracking mode may include the base station identifying a transmission or propagation characteristic for the active communication session. For example, the tracking mode may include the base station monitoring to ensure the propagation characteristic, e.g., the receive power from device 200, the transmitting frequency from device 200, the timing parameters associated with the transmissions from device 200, and/or the data rate parameters associated with the transmissions from the device 200, etc., are within a predefined range. While in the tracking mode, base station may support the continued active communication session with the device 200 provided that the propagation characteristics are within a predefined range. For example, the base station may continue the active communication session as long as the propagation parameters, although varying to a certain degree, stay within a predefined range. In some examples where the propagation characteristics change (e.g., suddenly change) above a threshold level, the base station may drop the link used for the active communication session.

Device 200 may receive an assignment for communications using an additional radio frequency spectrum band (e.g., F2). Device 200 may receive an assignment from a base station or other network entity for uplink communications on F2 in a CA application, for example. The second transceiver, however, may have a capability configuration that is different from the capability configuration of the first transceiver (e.g., the primary transceiver). In some examples, the second transceiver may not support communications on the second radio frequency spectrum band (e.g., F2). Thus, to support the assigned communications on F2, device 200 may reconfigure or otherwise use the first transceiver, which supports communications on F1 and F2, for the communications on F2. Device 200, however, may switch the first transceiver to a second antenna for the communications on F2 and couple the second transceiver to the first antenna to continue to perform the communications on F1. So, device 200 may initially use the first transceiver/first antenna for communications on F1 and, after receiving the assignment for communications on F2, couple the second transceiver/first antenna to continue to perform the communications on F1. The first transceiver/second antenna can be coupled to perform the assigned communications on F2.

Coupling the second transceiver to the first antenna (e.g., maintaining the first antenna) for the active communication session on F1 may reduce and/or eliminate changes (e.g., sudden changes) to the propagation characteristics for the communications on F1. For example, the first antenna may have different (e.g., substantially different) performance characteristics than the second antenna, e.g., due to interference caused by hand block. Suddenly switching to the second antenna for the active communication session on F1 may result in changes to the propagation characteristics for the communications on F1 that are outside of the predefined range. Thus, the base station may drop the link associated with the active communication session on F1. Coupling the second transceiver to the first antenna to continue to perform the communications on F1 may prevent the change (e.g., sudden change), e.g., maintaining the propagation characteristics to within the predefined range, and therefore avoid such link discontinuity between device 200 and the base station.

In some examples, device 200 may use the antenna switch diversity functions to couple or switch the second transceiver to the first antenna, to couple or switch the first transceiver to the second, antenna, or both. For example, device 200 may repurpose the antenna switch diversity function to maintain the active communication session on F1 using the first antenna by coupling the first antenna to the second transceiver.

In some examples, device 200 may make various adjustments to parameter(s) associated with the second transceiver. For example, device 200 may identify differences between the capability configuration of the first transceiver and the capability configuration of the second transceiver. The differences may be known based on RF design, in certain examples. In other examples, the differences may be determined based on current and/or previous monitoring functions for communications using the second transceiver. The device 200 may make adjustments to the parameter(s) of the second transceiver based on the identified differences. Adjusting the parameter(s) of the second transceiver may provide an input to the first antenna that is the same or substantially the same as an input to the first antenna that was previously provided by the first transceiver. Examples of the adjusted parameter(s) may include, but are not limited to, an output power of the second transceiver, an output frequency of the second transceiver, an output timing parameter of the second transceiver, and/or an output data rate of the second transceiver. Thus, the second transceiver may be adjusted to ensure the input to the first antenna matches or substantially matches the input previously provided by the first transceiver. This may also support maintaining the propagation characteristic for the active communication session on F1 to within the predefined range.

In some aspects, device 200 may also support employing the first antenna as a primary receive antenna for F1 and the second antenna as a diversity receive antenna for F1 before coupling the second transceiver to the first antenna and switching the first transceiver to the second antenna. The device 200 may also support employing the first antenna as a primary receive antenna for F1 and the second antenna as a diversity receive antenna for F1 after coupling the second transceiver to the first antenna and switching the first transceiver to the second antenna.

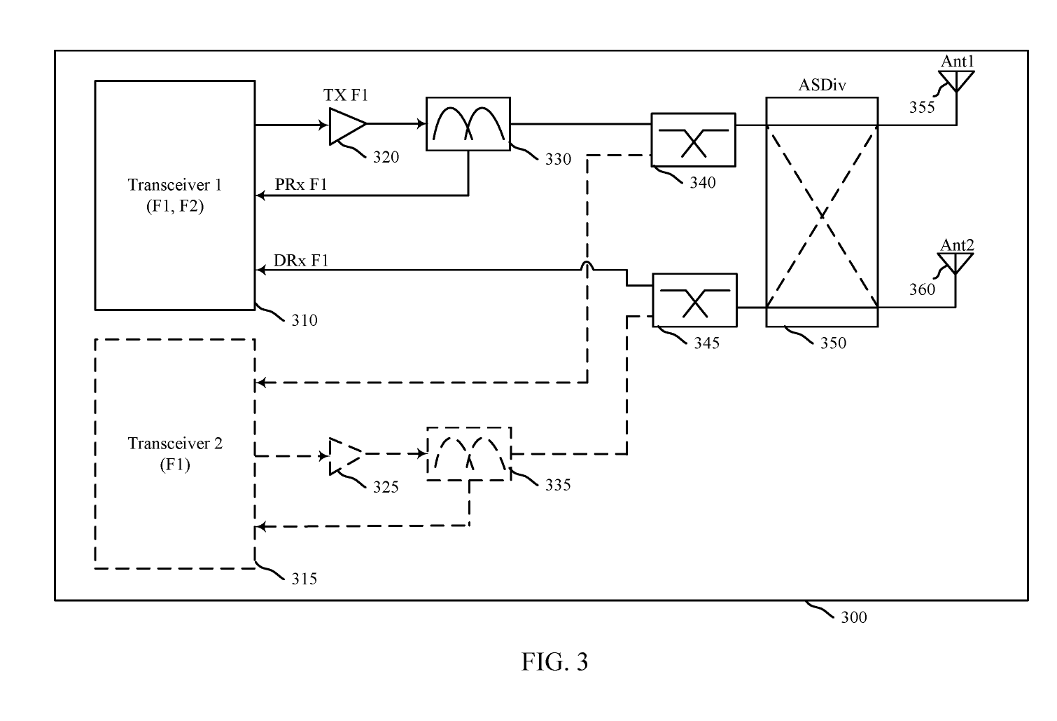

FIG. 3 illustrates an example of a block diagram showing aspects of a device 300 for improved resource management, in accordance with various aspects of the present disclosure. In some cases, device 300 may represent aspects of techniques performed by a UE 115 or a device 200 as described with reference to FIGS. 1 and/or 2. In some aspects, device 300 may be a component of a UE 115 and/or a device 200. Generally, device 300 may support resource management improvements by reducing and/or minimizing changes to a propagation characteristics from device 300 during an active communication session.

Device 300 may include a first transceiver 310, a second transceiver 315, a first amplifier 320, a second amplifier 325, a first duplexer 330, a second duplexer 335, a first switching component 340, a second switching component 345, an antenna switch diversity function 350, a first antenna 355 (Ant1), and/or a second antenna 360 (Ant2). The first transceiver 310 may have a first capability configuration that supports communications on a first radio frequency spectrum band (e.g., F1) and a second radio frequency spectrum band (e.g., F2). The second transceiver 315 may have a second capability configuration that supports communications in F1, e.g., the second transceiver 315 may not support communications on F2. The first transceiver 310 may, in some aspects, be considered a primary transceiver that is used for communications by device 300. The first transceiver 310 and the second transceiver 315 may also have other differences, e.g., transmit power, timing, etc.

Each of the first transceiver 310 and the second transceiver 315 may be a component of a communication chain. For example, a first communication chain may include the first transceiver 310, the first amplifier 320, the first duplexer 330, the first switching component 340, and at least one antenna, as determined by antenna switch diversity function 350. A second communication chain may include the second transceiver 315, the second amplifier 325, the second duplexer 335, the second switching component 345, and at least one antenna, as determined by antenna switch diversity function 350.

Device 300 may be configured to perform communications on F1 using the first communication chain and the first antenna 355. For example, the first transceiver 310 may perform uplink communications on F1 using the first amplifier 320, the first duplexer 330, the first switching component 340, and the first antenna 355. For example, the antenna switching diversity function 350 may be configured as a pass through switch, as indicated by the solid horizontal lines and the dashed crossover lines. Thus, the output of the switching component 340 may be coupled to the first antenna 355 by the antenna switching diversity function 350.

The first transceiver 310 may perform downlink communications (e.g., receive functions) on F1 using the first antenna 355 and the second antenna 360. For example, the duplexer 330 may couple the signal received on the first antenna 355 to the first transceiver 310 as a primary receive (PRx) signal. Diversity receive (DRx) may be performed using the second antenna 360 and the second switching component 345. For example, the second antenna 360 may be coupled to the second switching function 345 by the antenna switch diversity function 350. The second switching component 345 may couple the received signal as a diversity receive signal to the first transceiver 310.

In the example in FIG. 3, the device 300 may not be communicating using the first radio frequency spectrum band, e.g., F1. Thus, the second transceiver 315, the second amplifier 325, the second duplexer 335, and the second switching component 345 are inactive, as indicated by the dashed lines.

Broadly, the antenna switch diversity function 350 may be designed to provide selective transmit diversity to combat hand-block, or other RF impairments. According to aspects of the present disclosure, the antenna switch diversity function 350 may be used (e.g., repurposed) to mitigate the performance degradation due to changing antenna and/or transceiver for uplink CA configuration/deconfiguration. Changing the antenna switching diversity function 350 configuration when antenna changing is needed due to uplink CA configuration/deconfiguration may mitigate any differences to the propagation characteristics associated with an ongoing active communication session.

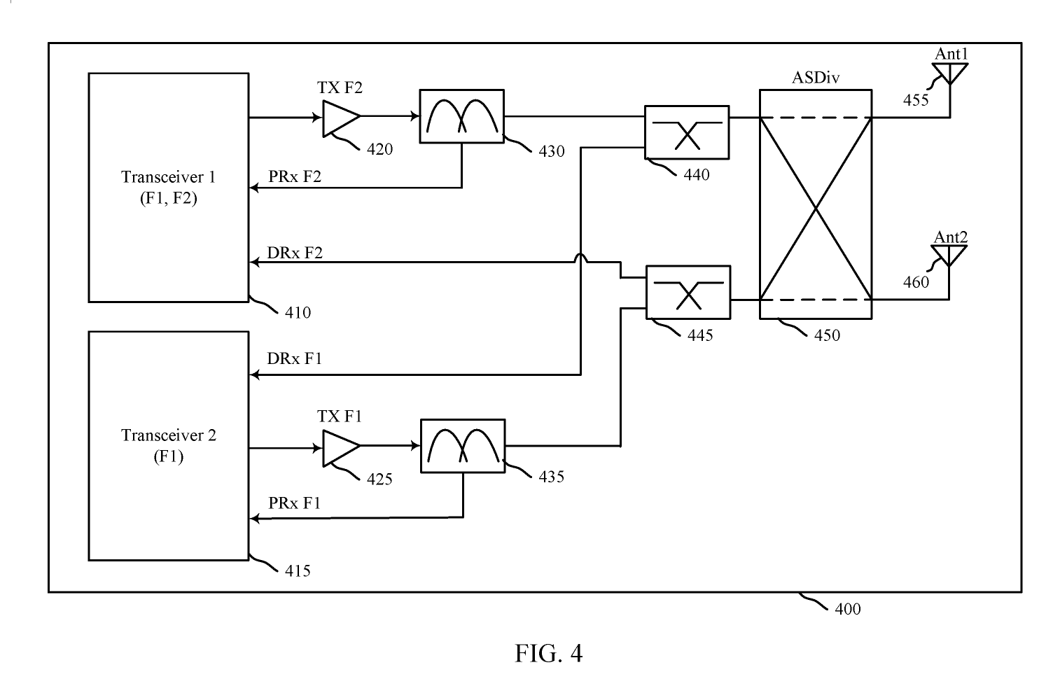

FIG. 4 illustrates an example of a block diagram showing aspects of a device 400 for improved resource management, in accordance with various aspects of the present disclosure. In some cases, device 400 may represent aspects of techniques performed by a UE 115, a device 200, and/or a device 300 as described with reference to FIGS. 1 through 3. In some aspects, device 400 may be a component of a UE 115 and/or a device 200. Generally, device 400 may support resource management improvements by reducing and/or minimizing changes to a propagation characteristics from device 400 during an active communication session.

Device 400 may include a first transceiver 410, a second transceiver 415, a first amplifier 420, a second amplifier 425, a first duplexer 430, a second duplexer 435, a first switching component 440, a second switching component 445, an antenna switch diversity function 450, a first antenna 455 (Ant1), and/or a second antenna 460 (Ant2). The first transceiver 410 may have a first capability configuration that supports communications on a first radio frequency spectrum band (e.g., F1) and a second radio frequency spectrum band (e.g., F2). The second transceiver 415 may have a second capability configuration that supports communications in F1, e.g., the second transceiver 415 may not support communications on F2. The first transceiver 410 and the second transceiver 415 may also have other differences, e.g., transmit power, timing, etc.

In the example in FIG. 4, device 400 may be configured to support resource management improvement techniques by using the antenna switch diversity function 450 to mitigate discontinuity during an active communication session on F1. For example, device 400 may be configured to perform communications on F1 using the first transceiver 410 and the first antenna 455. Device 400 may receive an assignment for uplink communications using F2. As the second transceiver 415 does not support communications on F2, device 400 may use the antenna switch diversity function 450 to couple second transceiver 415 to the first antenna 455 to perform (e.g., continue performing) the uplink communications on F1. For example, the antenna switching diversity function 450 may be configured as a crossover switch, as indicated by the solid crossover lines and the dashed horizontal lines. Device 400 may switch the first transceiver 410 to the second antenna 460 for the assigned communications on F2. Thus, the antenna switch diversity function 450 may be used to maintain the use of the first antenna 455 for the active communication session on F1. This may maintain the propagation characteristics of the active communication session on F1 to within a predefined threshold or range and may reduce and/or avoid link loss between device 400 and a base station, for example.

The first transceiver 410 may perform uplink communications (e.g., transmit operations) on F2 using the first amplifier 420, the first duplexer 430, the first switching component 440, and the second antenna 460, as coupled by the antenna switch diversity function 450. The first transceiver 410 may perform downlink communications (e.g., receive functions) on F2 using both the first antenna 455 and the second antenna 460. For example, the first duplexer 430 may couple the signal received on the second antenna 460 to the first transceiver 410 as a primary receive (PRx) signal. Diversity receive (DRx) may be performed using the first antenna 455 and the second switching component 445. For example, the first antenna 455 may be coupled to the second switching component 445 by the antenna switch diversity function 450. The second switching component 445 may couple the received signal as a diversity receive signal to the first transceiver 410.

The second transceiver 415 may perform uplink communications (e.g., transmit operations) on F1 using the second amplifier 425, the second duplexer 435, the second switching component 445, and the first antenna 455, as coupled by the antenna switch diversity function 450. The second transceiver 415 may perform downlink communications (e.g., receive functions) on F1 using both the first antenna 455 and the second antenna 460. For example, the second duplexer 435 may couple the signal received on the first antenna 455 to the second transceiver 415 as a primary receive (PRx) signal. Diversity receive (DRx) may be performed using the second antenna 460 and the first switching component 440. For example, the second antenna 460 may be coupled to the first switching component 440 by the antenna switch diversity function 450. The first switching component 440 may couple the received signal as a diversity receive signal to the second transceiver 415.

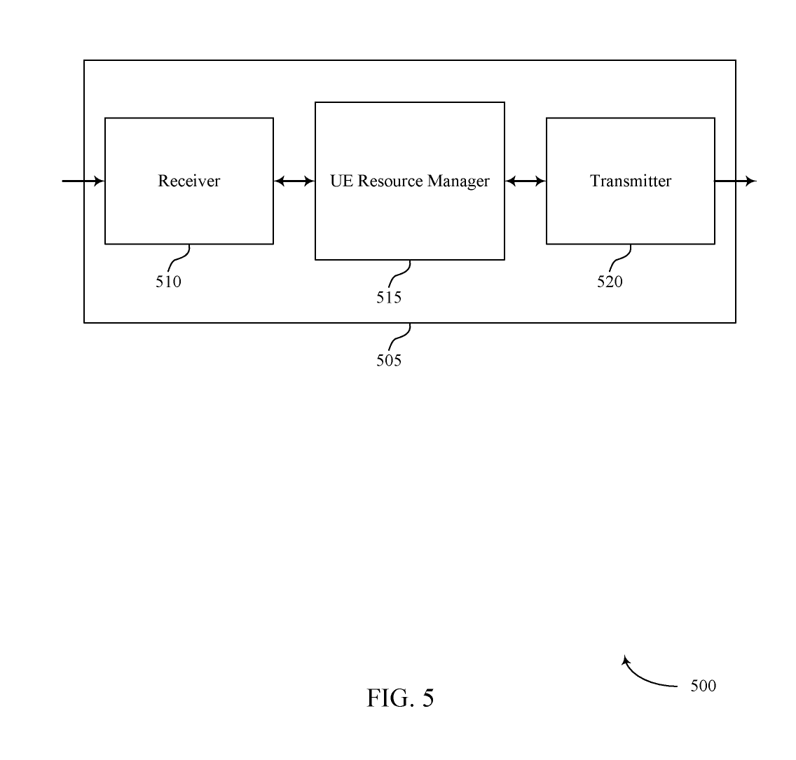

FIG. 5 shows a block diagram 500 of a wireless device 505 that supports improved resource management in accordance with various aspects of the present disclosure. Wireless device 505 may be an example of aspects of a UE 115, a device 200, a device, 300, and/or a device 400 as described with reference to FIGS. 1 through 4. Wireless device 505 may include a receiver 510, a UE resource manager 515, and a transmitter 520. Wireless device 505 may also include a processor. Each of these components may be in communication with one another (e.g., via one or more buses).

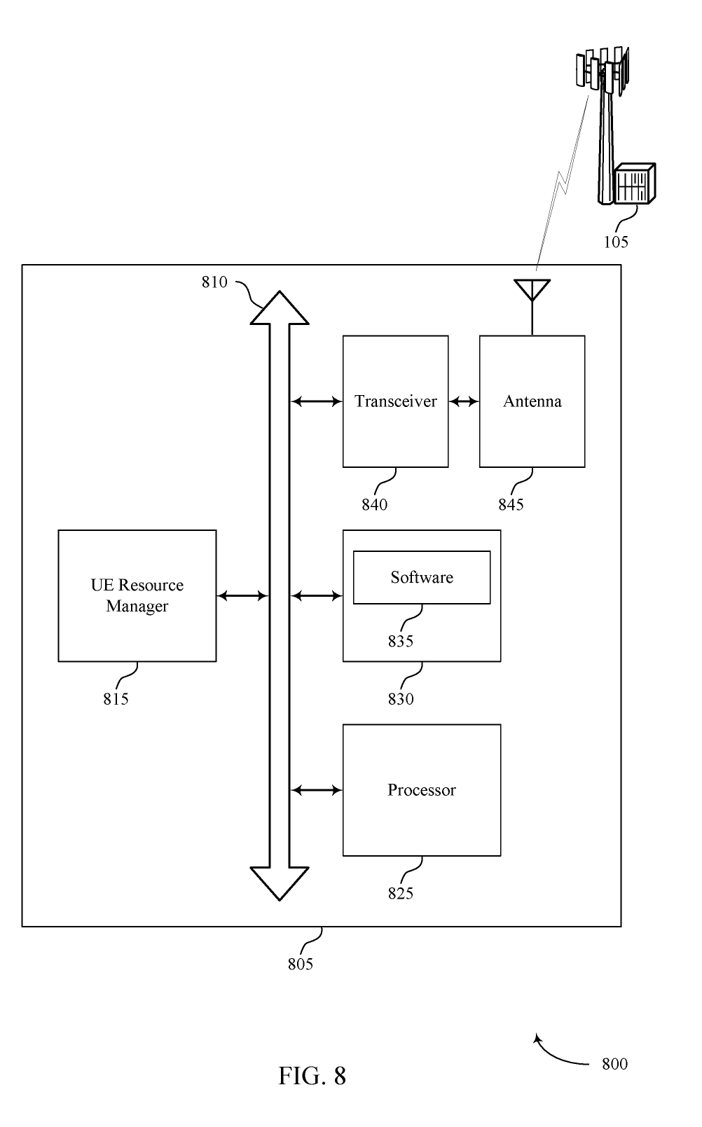

The receiver 510 may receive information such as packets, user data, or control information associated with various information channels (e.g., control channels, data channels, and information related to improved resource management, etc.). Information may be passed on to other components of the device. The receiver 510 may be an example of aspects of the transceiver 840 described with reference to FIG. 8. The receiver 510 may also be an example of one or more of the transceivers illustrated in FIGS. 3 and 4.

The UE resource manager 515 may perform uplink communications on a first radio frequency spectrum band using a first transceiver and a first antenna, the first transceiver having a first capability configuration, receive an assignment for uplink communications on a second radio frequency spectrum band, couple a second transceiver to the first antenna so as to perform the uplink communications on the first radio frequency spectrum band using the second transceiver and the first antenna, the second transceiver having a second capability configuration that is different from the first capability configuration with respect to at least the second radio frequency spectrum band, and switch the first transceiver to a second antenna for the uplink communications on the second radio frequency spectrum band. The UE resource manager 515 may be an example of aspects of the UE resource manager 815 described with reference to FIG. 8.

The transmitter 520 may transmit signals generated by other components of the device. In some examples, the transmitter 520 may be collocated with a receiver 505 in a transceiver module. For example, the transmitter 520 may be an example of aspects of the transceiver 840 described with reference to FIG. 8. The transmitter 520 may also be an example of one or more of the transceivers illustrated in FIGS. 3 and 4. The transmitter 520 may be coupled to one of multiple antennas.

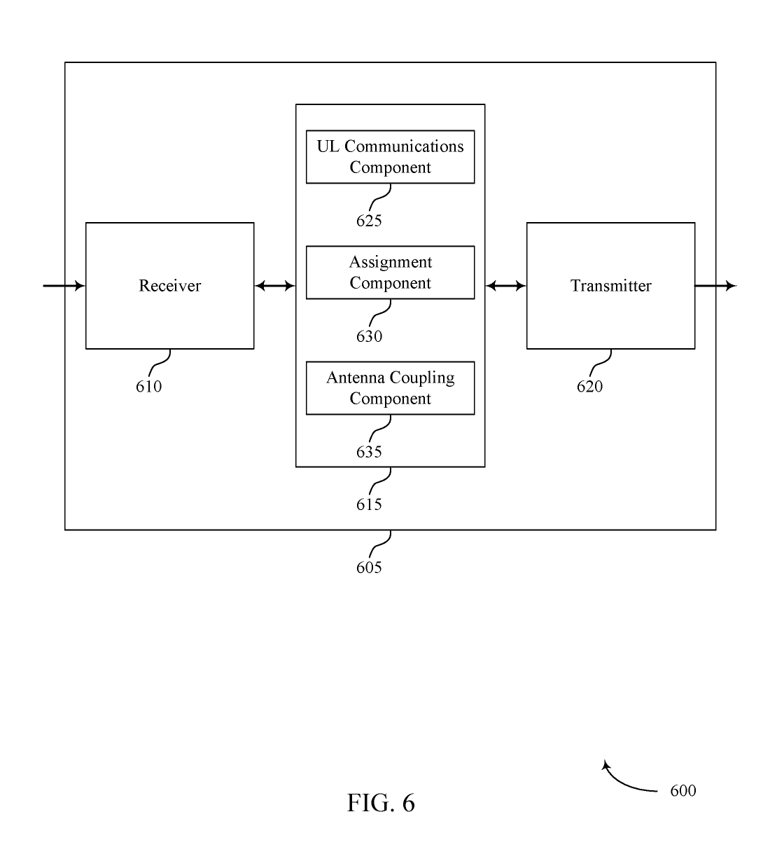

FIG. 6 shows a block diagram 600 of a wireless device 605 that supports improved resource management in accordance with various aspects of the present disclosure. Wireless device 605 may be an example of aspects of a device 200, a device 300, a device 400, a wireless device 505 or a UE 115 as described with reference to FIGS. 1 through 5. Wireless device 605 may include a receiver 610, a UE resource manager 615, and a transmitter 620. Wireless device 605 may also include a processor. Each of these components may be in communication with one another (e.g., via one or more buses).

The receiver 610 may receive information such as packets, user data, or control information associated with various information channels (e.g., control channels, data channels, and information related to improved resource management, etc.). Information may be passed on to other components of the device. The receiver 610 may be an example of aspects of the transceiver 840 described with reference to FIG. 8. The receiver 610 may also be an example of one or more of the transceivers illustrated in FIGS. 3 and 4.

The UE resource manager 615 may be an example of aspects of the UE resource manager 815 described with reference to FIG. 8. The UE resource manager 615 may also include an UL communications component 625, an assignment component 630, and an antenna coupling component 635.

The UL communications component 625 may perform uplink communications on a first radio frequency spectrum band using a first transceiver and a first antenna, the first transceiver having a first capability configuration. In some cases, the first capability configuration supports uplink communications on the first radio frequency spectrum band and a second radio frequency spectrum band. In some cases, the uplink communications on the first radio frequency spectrum band and the second radio frequency spectrum band include uplink carrier aggregation communications.

The assignment component 630 may receive an assignment for uplink communications on a second radio frequency spectrum band. The antenna coupling component 635 may couple a second transceiver to the first antenna so as to perform the uplink communications on the first radio frequency spectrum band using the second transceiver and the first antenna, the second transceiver having a second capability configuration that is different from the first capability configuration with respect to at least the second radio frequency spectrum band, and switch the first transceiver to a second antenna for the uplink communications on the second radio frequency spectrum band.

The antenna coupling component 635 may also employ the first antenna as a primary receive antenna for the first radio frequency spectrum band and the second antenna as a diversity receive antenna for the first radio frequency spectrum band before coupling the second transceiver to the first antenna and switching the first transceiver to the second antenna, as well as after coupling the second transceiver to the first antenna and switching the first transceiver to the second antenna. The antenna coupling component 635 may also employ the first antenna and the first transceiver as a primary communication chain when uplink communications on the first radio frequency spectrum band are used.

In some cases, coupling the second transceiver to the first antenna includes using an antenna switch diversity function to couple the second transceiver to the first antenna, or switching the first transceiver to the second antenna including using an antenna switch diversity function to switch the first transceiver to the second antenna. In some cases, coupling the second transceiver to the first antenna includes maintaining a propagation characteristic of the uplink communications on the first radio frequency spectrum band to within a predefined range. In some cases, coupling the second transceiver to the first antenna includes coupling the second transceiver to the first antenna during an active session of the uplink communications on the first radio frequency spectrum band. In some cases, the second capability configuration does not support uplink communications on the second radio frequency spectrum band.

The transmitter 620 may transmit signals generated by other components of the device. In some examples, the transmitter 620 may be collocated with a receiver 605 in a transceiver module. For example, the transmitter 620 may be an example of aspects of the transceiver 840 described with reference to FIG. 8. The transmitter 620 may also be an example of one or more of the transceivers illustrated in FIGS. 3 and 4. The transmitter 620 may be coupled to one of multiple antennas.

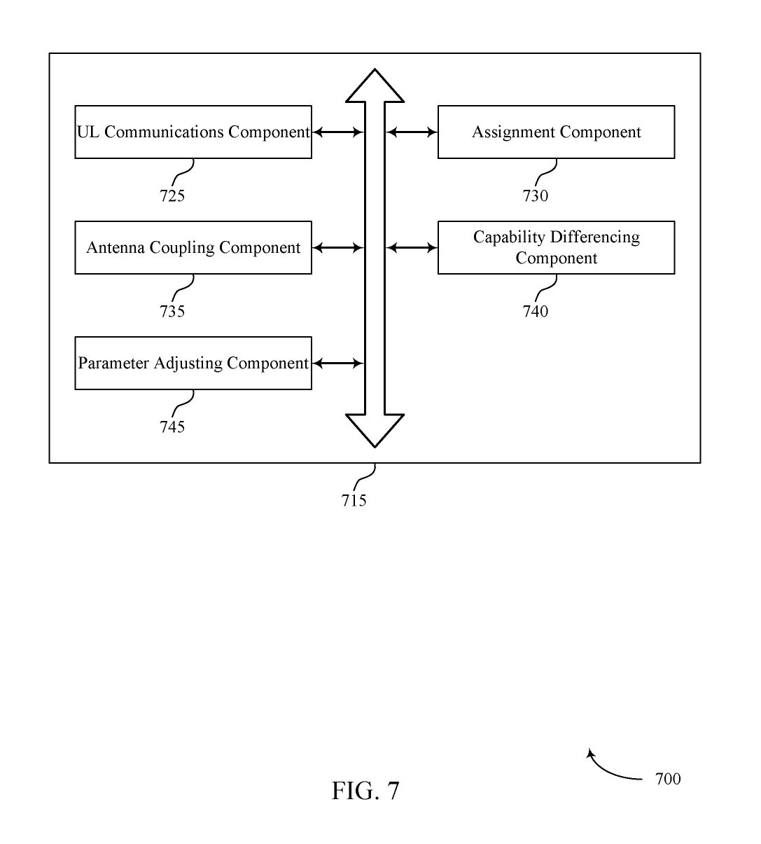

FIG. 7 shows a block diagram 700 of a UE resource manager 715 that supports improved resource management in accordance with various aspects of the present disclosure. The UE resource manager 715 may be an example of aspects of a UE resource manager 515, a UE resource manager 615, or a UE resource manager 815 described with reference to FIGS. 5, 6, and 8. The UE resource manager 715 may include an UL communications component 725, an assignment component 730, an antenna coupling component 735, a capability differencing component 740, and a parameter adjusting component 745. Each of these modules may communicate, directly or indirectly, with one another (e.g., via one or more buses).

The UL communications component 725 may perform uplink communications on a first radio frequency spectrum band using a first transceiver and a first antenna, the first transceiver having a first capability configuration. The assignment component 730 may receive an assignment for uplink communications on a second radio frequency spectrum band.

The antenna coupling component 735 may couple a second transceiver to the first antenna so as to perform the uplink communications on the first radio frequency spectrum band using the second transceiver and the first antenna, the second transceiver having a second capability configuration that is different from the first capability configuration with respect to at least the second radio frequency spectrum band, switch the first transceiver to a second antenna for the uplink communications on the second radio frequency spectrum band, and/or employ the first antenna as a primary receive antenna for the first radio frequency spectrum band and the second antenna as a diversity receive antenna for the first radio frequency spectrum band before coupling the second transceiver to the first antenna and switching the first transceiver to the second antenna.

The antenna coupling component 735 may also employ the first antenna as a primary receive antenna for the first radio frequency spectrum band and the second antenna as a diversity receive antenna for the first radio frequency spectrum band after coupling the second transceiver to the first antenna and switching the first transceiver to the second antenna, and/or employ the first antenna and the first transceiver as a primary communication chain when uplink communications on the first radio frequency spectrum band are used.

The capability differencing component 740 may identify a difference between the first capability configuration and the second capability configuration. The parameter adjusting component 745 may adjust at least one parameter associated with the second transceiver based on the difference. In some cases, the at least one parameter includes at least one of an output power of the second transceiver, an output frequency of the second transceiver, an output timing parameter of the second transceiver, or an output data rate of the second transceiver. In some cases, adjusting the at least one parameter includes: adjusting the at least one parameter of the second transceiver to provide an input to the first antenna that is the same or substantially the same as an input to the first antenna provided by the first transceiver.

FIG. 8 shows a diagram of a system 800 including a wireless device 805 that supports improved resource management in accordance with various aspects of the present disclosure. Wireless device 805 may be an example of a device 200, a device 300, a device 400, a wireless device 500, a wireless device 600, or a UE 115 as described above, e.g., with reference to FIGS. 1 through 6.

Wireless device 805 may include components for bi-directional voice and data communications including components for transmitting and receiving communications, including a UE resource manager 815, a processor 825, a memory 830, a software 835, a transceiver 840, and an antenna 845.

The processor 825 may include an intelligent hardware device, (e.g., a central processing unit (CPU), a microcontroller, an application specific integrated circuit (ASIC), etc.) The memory 830 may include random access memory (RAM) and read only memory (ROM). The memory 830 may store computer-readable, computer-executable software 835 including instructions that, when executed, cause the processor 825 to perform various functions described herein (e.g., improved resource management, etc.). In some cases, the software 835 may not be directly executable by the processor 825 but may cause a computer (e.g., when compiled and executed) to perform functions described herein.

The transceiver 840 may, for example, communicate bi-directionally, via one or more antennas, wired, or wireless links as described above. For example, the transceiver 840 may communicate bi-directionally with another wireless device. The transceiver 840 may also include a modem to modulate the packets and provide the modulated packets to the antennas for transmission, and to demodulate packets received from the antennas. In some cases, the wireless device may have more than one antenna 845, which may be capable of concurrently transmitting or receiving multiple wireless transmissions.

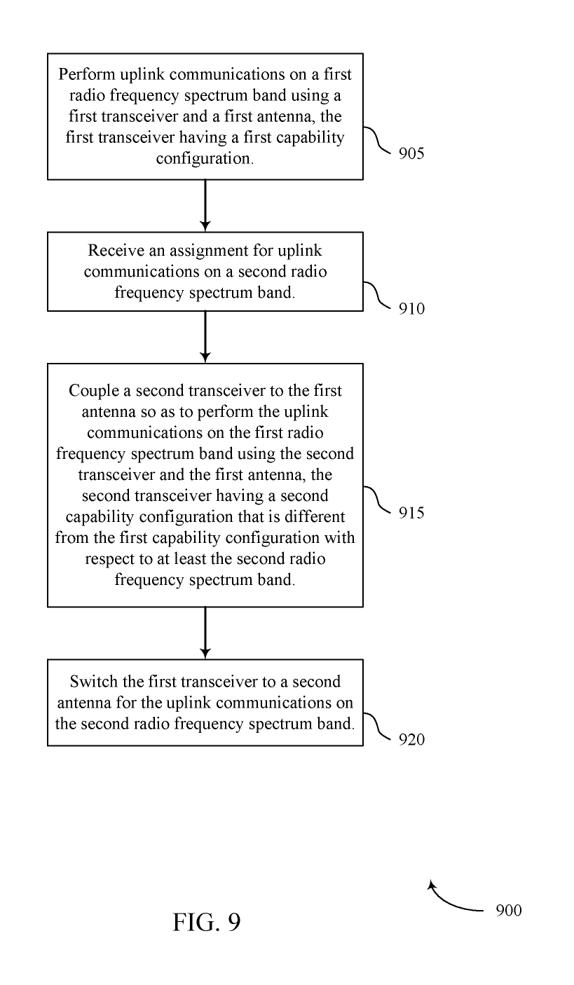

FIG. 9 shows a flowchart illustrating a method 900 for improved resource management, in accordance with various aspects of the present disclosure. The operations of method 900 may be implemented by a device 200, a device 300, a device 400, and/or a UE 115 or its components as described herein. For example, the operations of method 900 may be performed by a UE resource manager as described with reference to FIGS. 5 through 7. In some examples, a UE 115 may execute a set of one or more codes to control the functional elements of the device to perform the functions described below. Additionally or alternatively, the UE 115 may perform aspects the functions described below using special-purpose hardware.

At block 905, the UE 115 may perform uplink communications on a first radio frequency spectrum band using a first transceiver and a first antenna, the first transceiver having a first capability configuration. The operations of block 905 may be performed according to the methods described with reference to FIGS. 2 through 4. In certain examples, the operations of block 905 may be performed by a UL communications component as described with reference to FIGS. 5 through 7.

At block 910, the UE 115 may receive an assignment for uplink communications on a second radio frequency spectrum band. The operations of block 910 may be performed according to the methods described with reference to FIGS. 2 through 4. In certain examples, the operations of block 910 may be performed by an assignment component as described with reference to FIGS. 5 through 7.

At block 915, the UE 115 may couple a second transceiver to the first antenna so as to perform the uplink communications on the first radio frequency spectrum band using the second transceiver and the first antenna, the second transceiver having a second capability configuration that is different from the first capability configuration with respect to at least the second radio frequency spectrum band. The operations of block 915 may be performed according to the methods described with reference to FIGS. 2 through 4. In certain examples, the operations of block 915 may be performed by an antenna coupling component as described with reference to FIGS. 5 through 7.

At block 920, the UE 115 may switch the first transceiver to a second antenna for the uplink communications on the second radio frequency spectrum band. The operations of block 920 may be performed according to the methods described with reference to FIGS. 2 through 4. In certain examples, the operations of block 920 may be performed by an antenna coupling component as described with reference to FIGS. 5 through 7.

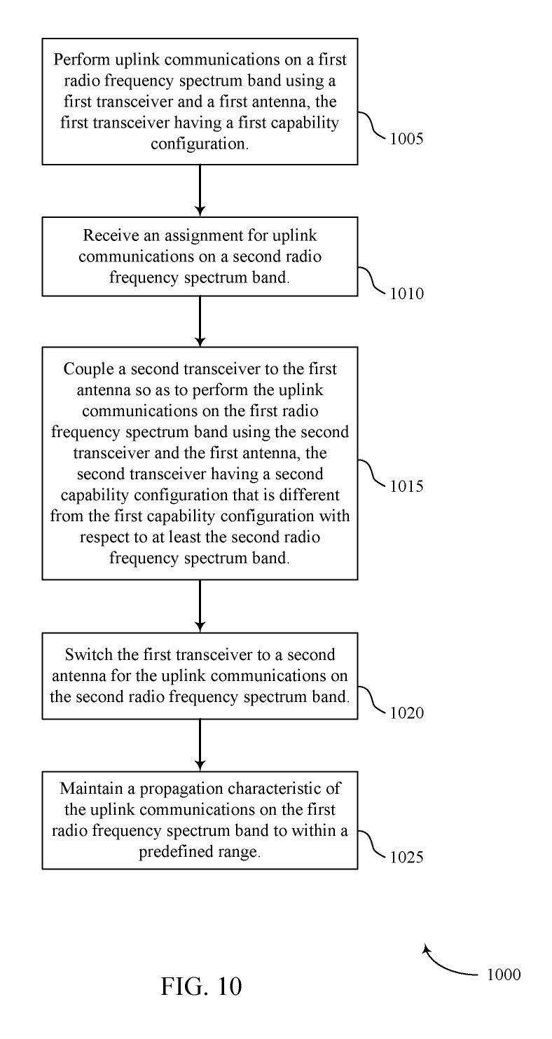

FIG. 10 shows a flowchart illustrating a method 1000 for improved resource management, in accordance with various aspects of the present disclosure. The operations of method 1000 may be implemented by a device 200, a device 300, a device 400, and/or a UE 115 or its components as described herein. For example, the operations of method 1000 may be performed by a UE resource manager as described with reference to FIGS. 5 through 7. In some examples, a UE 115 may execute a set of one or more codes to control the functional elements of the device to perform the functions described below. Additionally or alternatively, the UE 115 may perform aspects the functions described below using special-purpose hardware.

At block 1005, the UE 115 may perform uplink communications on a first radio frequency spectrum band using a first transceiver and a first antenna, the first transceiver having a first capability configuration. The operations of block 1005 may be performed according to the methods described with reference to FIGS. 2 through 4. In certain examples, the operations of block 1005 may be performed by a UL communications component as described with reference to FIGS. 5 through 7.

At block 1010, the UE 115 may receive an assignment for uplink communications on a second radio frequency spectrum band. The operations of block 1010 may be performed according to the methods described with reference to FIGS. 2 through 4. In certain examples, the operations of block 1010 may be performed by an assignment component as described with reference to FIGS. 5 through 7.

At block 1015, the UE 115 may couple a second transceiver to the first antenna so as to perform the uplink communications on the first radio frequency spectrum band using the second transceiver and the first antenna, the second transceiver having a second capability configuration that is different from the first capability configuration with respect to at least the second radio frequency spectrum band. The operations of block 1015 may be performed according to the methods described with reference to FIGS. 2 through 4. In certain examples, the operations of block 1015 may be performed by an antenna coupling component as described with reference to FIGS. 5 through 7.

At block 1020, the UE 115 may switch the first transceiver to a second antenna for the uplink communications on the second radio frequency spectrum band. The operations of block 1020 may be performed according to the methods described with reference to FIGS. 2 through 4. In certain examples, the operations of block 1020 may be performed by an antenna coupling component as described with reference to FIGS. 5 through 7.

At block 1025, the UE 115 may maintain a propagation characteristic of the uplink communications on the first radio frequency spectrum band to within a predefined range. The operations of block 1025 may be performed according to the methods described with reference to FIGS. 2 through 4. In certain examples, the operations of block 1025 may be performed by an antenna coupling component as described with reference to FIGS. 5 through 7.

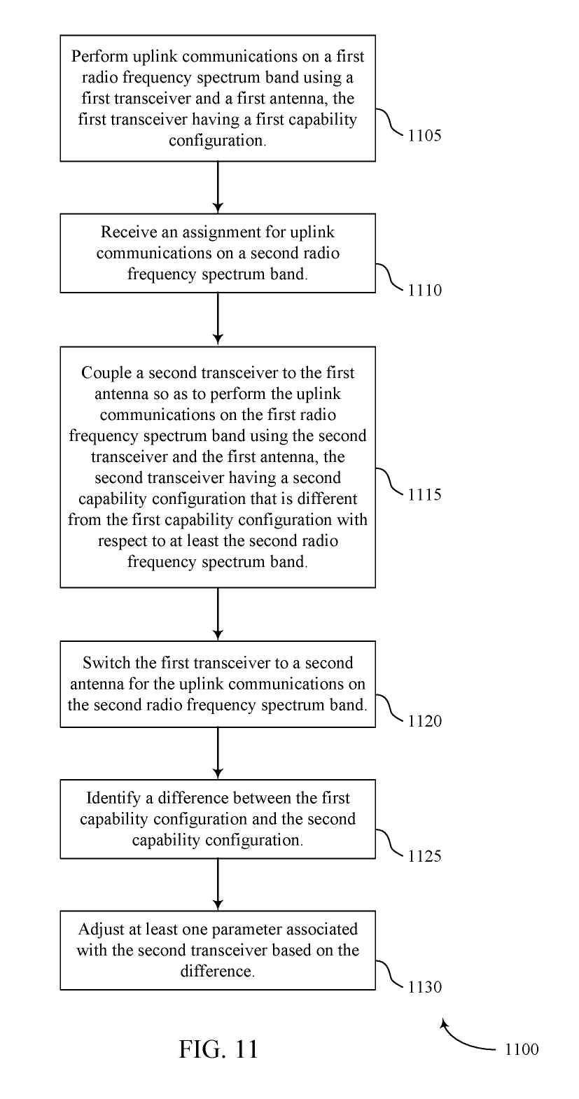

FIG. 11 shows a flowchart illustrating a method 1100 for improved resource management, in accordance with various aspects of the present disclosure. The operations of method 1100 may be implemented by a device 200, a device 300, a device 400, and/or a UE 115 or its components as described herein. For example, the operations of method 1100 may be performed by a UE resource manager as described with reference to FIGS. 5 through 7. In some examples, a UE 115 may execute a set of one or more codes to control the functional elements of the device to perform the functions described below. Additionally or alternatively, the UE 115 may perform aspects the functions described below using special-purpose hardware.

At block 1105, the UE 115 may perform uplink communications on a first radio frequency spectrum band using a first transceiver and a first antenna, the first transceiver having a first capability configuration. The operations of block 1105 may be performed according to the methods described with reference to FIGS. 2 through 4. In certain examples, the operations of block 1105 may be performed by a UL communications component 725 as described with reference to FIGS. 5 through 7.

At block 1110, the UE 115 may receive an assignment for uplink communications on a second radio frequency spectrum band. The operations of block 1110 may be performed according to the methods described with reference to FIGS. 2 through 4. In certain examples, the operations of block 1110 may be performed by an assignment component 730 as described with reference to FIGS. 5 through 7.

At block 1115, the UE 115 may couple a second transceiver to the first antenna so as to perform the uplink communications on the first radio frequency spectrum band using the second transceiver and the first antenna, the second transceiver having a second capability configuration that is different from the first capability configuration with respect to at least the second radio frequency spectrum band. The operations of block 1115 may be performed according to the methods described with reference to FIGS. 2 through 4. In certain examples, the operations of block 1115 may be performed by an antenna coupling component 735 as described with reference to FIGS. 5 through 7.

At block 1120, the UE 115 may switch the first transceiver to a second antenna for the uplink communications on the second radio frequency spectrum band. The operations of block 1120 may be performed according to the methods described with reference to FIGS. 2 through 4. In certain examples, the operations of block 1120 may be performed by an antenna coupling component 735 as described with reference to FIGS. 5 through 7.

At block 1125, the UE 115 may identify a difference between the first capability configuration and the second capability configuration. The operations of block 1125 may be performed according to the methods described with reference to FIGS. 2 through 4. In certain examples, the operations of block 1125 may be performed by a capability differencing component 740 as described with reference to FIGS. 5 through 7.

At block 1130, the UE 115 may adjust at least one parameter associated with the second transceiver based on the difference. The operations of block 1130 may be performed according to the methods described with reference to FIGS. 2 through 4. In certain examples, the operations of block 1130 may be performed by a parameter adjusting component 745 as described with reference to FIGS. 5 through 7.

It should be noted that the methods described above describe possible implementations, and that the operations and the steps may be rearranged or otherwise modified and that other implementations are possible. Furthermore, aspects from two or more of the methods may be combined.

Techniques described herein may be used for various wireless communications systems such as CDMA, TDMA, FDMA, OFDMA, single carrier frequency division multiple access (SC-FDMA), and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM).

An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc. UTRA and E-UTRA are part of Universal Mobile Telecommunications system (UMTS). 3GPP Long Term Evolution (LTE) and LTE-Advanced (LTE-A) are new releases of Universal Mobile Telecommunications System (UMTS) that use E-UTRA. UTRA, E-UTRA, UMTS, LTE, LTE-A, and Global System for Mobile communications (GSM) are described in documents from the organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. While aspects an LTE system may be described for purposes of example, and LTE terminology may be used in much of the description, the techniques described herein are applicable beyond LTE applications.

In LTE/LTE-A networks, including such networks described herein, the term evolved node B (eNB) may be generally used to describe the base stations. The wireless communications system or systems described herein may include a heterogeneous LTE/LTE-A network in which different types of evolved node B (eNBs) provide coverage for various geographical regions. For example, each eNB or base station may provide communication coverage for a macro cell, a small cell, or other types of cell. The term “cell” is a 3GPP term that can be used to describe a base station, a carrier or component carrier associated with a base station, or a coverage area (e.g., sector, etc.) of a carrier or base station, depending on context.

Base stations may include or may be referred to by those skilled in the art as a base transceiver station, a radio base station, an access point, a radio transceiver, a NodeB, eNodeB (eNB), Home NodeB, a Home eNodeB, or some other suitable terminology. The geographic coverage area for a base station may be divided into sectors making up only a portion of the coverage area. The wireless communications system or systems described herein may include base stations of different types (e.g., macro or small cell base stations). The UEs described herein may be able to communicate with various types of base stations and network equipment including macro eNBs, small cell eNBs, relay base stations, and the like. There may be overlapping geographic coverage areas for different technologies.

A macro cell generally covers a relatively large geographic area (e.g., several kilometers in radius) and may allow unrestricted access by UEs with service subscriptions with the network provider. A small cell is a lower-powered base station, as compared with a macro cell, that may operate in the same or different (e.g., licensed, unlicensed, etc.) frequency bands as macro cells. Small cells may include pico cells, femto cells, and micro cells according to various examples. A pico cell, for example, may cover a small geographic area and may allow unrestricted access by UEs with service subscriptions with the network provider. A femto cell may also cover a small geographic area (e.g., a home) and may provide restricted access by UEs having an association with the femto cell (e.g., UEs in a closed subscriber group (CSG), UEs for users in the home, and the like). An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells (e.g., component carriers). A UE may be able to communicate with various types of base stations and network equipment including macro eNBs, small cell eNBs, relay base stations, and the like.

The wireless communications system or systems described herein may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

The downlink transmissions described herein may also be called forward link transmissions while the uplink transmissions may also be called reverse link transmissions. Each communication link described herein—including, for example, wireless communications system 100 of FIG. 1—may include one or more carriers, where each carrier may be a signal made up of multiple sub-carriers (e.g., waveform signals of different frequencies).

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a digital signal processor (DSP) and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for wireless communication, comprising:
performing uplink communications on a first radio frequency spectrum band using a first transceiver and a first antenna, the first transceiver having a first capability configuration;
receiving an assignment for uplink communications on a second radio frequency spectrum band;
coupling a second transceiver to the first antenna so as to perform the uplink communications on the first radio frequency spectrum band using the second transceiver and the first antenna, the second transceiver having a second capability configuration that is different from the first capability configuration with respect to at least the second radio frequency spectrum band; and
switching the first transceiver to a second antenna for the uplink communications on the second radio frequency spectrum band.

2. The method of claim 1, wherein coupling the second transceiver to the first antenna comprises at least one of:
using an antenna switch diversity function to couple the second transceiver to the first antenna, or switching the first transceiver to the second antenna including using an antenna switch diversity function to switch the first transceiver to the second antenna.

3. The method of claim 1, wherein coupling the second transceiver to the first antenna comprises:
maintaining a propagation characteristic of the uplink communications on the first radio frequency spectrum band to within a predefined range.

4. The method of claim 1, wherein coupling the second transceiver to the first antenna comprises:
coupling the second transceiver to the first antenna during an active session of the uplink communications on the first radio frequency spectrum band.

5. The method of claim 1, further comprising:
identifying a difference between the first capability configuration and the second capability configuration; and
adjusting at least one parameter associated with the second transceiver based at least in part on the difference.

6. The method of claim 5, wherein the at least one parameter comprises at least one of an output power of the second transceiver, an output frequency of the second transceiver, an output timing parameter of the second transceiver, or an output data rate of the second transceiver.

7. The method of claim 5, wherein adjusting the at least one parameter comprises:
adjusting the at least one parameter of the second transceiver to provide an input to the first antenna that is substantially the same as an input to the first antenna provided by the first transceiver.

8. The method of claim 1, wherein the second capability configuration does not support uplink communications on the second radio frequency spectrum band; and
the first capability configuration supports uplink communications on the first radio frequency spectrum band and the second radio frequency spectrum band.

9. The method of claim 1, wherein the uplink communications on the first radio frequency spectrum band and the second radio frequency spectrum band comprise uplink carrier aggregation communications.

10. The method of claim 1, further comprising:
employing the first antenna as a primary receive antenna for the first radio frequency spectrum band and the second antenna as a diversity receive antenna for the first radio frequency spectrum band before coupling the second transceiver to the first antenna and switching the first transceiver to the second antenna; and
employing the first antenna as a primary receive antenna for the first radio frequency spectrum band and the second antenna as a diversity receive antenna for the first radio frequency spectrum band after coupling the second transceiver to the first antenna and switching the first transceiver to the second antenna.

11. The method of claim 1, further comprising:
employing the first antenna and the first transceiver as a primary communication chain when uplink communications on the first radio frequency spectrum band are used.

12. An apparatus for wireless communication, comprising:
means for performing uplink communications on a first radio frequency spectrum band using a first transceiver and a first antenna, the first transceiver having a first capability configuration;
means for receiving an assignment for uplink communications on a second radio frequency spectrum band;
means for coupling a second transceiver to the first antenna so as to perform the uplink communications on the first radio frequency spectrum band using the second transceiver and the first antenna, the second transceiver having a second capability configuration that is different from the first capability configuration with respect to at least the second radio frequency spectrum band; and
means for switching the first transceiver to a second antenna for the uplink communications on the second radio frequency spectrum band.

13. An apparatus for wireless communication, in a system comprising:
a processor;
memory in electronic communication with the processor; and
one or more instructions stored in the memory and operable, when executed by the processor, to cause the apparatus to:
perform uplink communications on a first radio frequency spectrum band using a first transceiver and a first antenna, the first transceiver having a first capability configuration;
receive an assignment for uplink communications on a second radio frequency spectrum band;
couple a second transceiver to the first antenna so as to perform the uplink communications on the first radio frequency spectrum band using the second transceiver and the first antenna, the second transceiver having a second capability configuration that is different from the first capability configuration with respect to at least the second radio frequency spectrum band; and
switch the first transceiver to a second antenna for the uplink communications on the second radio frequency spectrum band.

14. The apparatus of claim 13, wherein the one or more instructions operable to cause the apparatus to couple the second transceiver to the first antenna comprise one or more instructions operable to cause the apparatus to do at least one of:
use an antenna switch diversity function to couple the second transceiver to the first antenna, or switch the first transceiver to the second antenna including using an antenna switch diversity function to switch the first transceiver to the second antenna.

15. The apparatus of claim 13, wherein the one or more instructions operable to cause the apparatus to couple the second transceiver to the first antenna comprise one or more instructions operable to cause the apparatus to:
maintain a propagation characteristic of the uplink communications on the first radio frequency spectrum band to within a predefined range.

16. The apparatus of claim 13, wherein the one or more instructions operable to cause the apparatus to couple the second transceiver to the first antenna comprise one or more instructions operable to cause the apparatus to:
couple the second transceiver to the first antenna during an active session of the uplink communications on the first radio frequency spectrum band.

17. The apparatus of claim 13, wherein the one or more instructions are further executable by the processor to:
identify a difference between the first capability configuration and the second capability configuration; and
adjust at least one parameter associated with the second transceiver based at least in part on the difference.

18. The apparatus of claim 17, wherein the at least one parameter comprises at least one of an output power of the second transceiver, an output frequency of the second transceiver, an output timing parameter of the second transceiver, or an output data rate of the second transceiver.

19. The apparatus of claim 17, wherein the one or more instructions operable to cause the apparatus to adjust the at least one parameter comprise one or more instructions operable to cause the apparatus to:
adjust the at least one parameter of the second transceiver to provide an input to the first antenna that is substantially the same as an input to the first antenna provided by the first transceiver.

20. The apparatus of claim 13, wherein
the second capability configuration does not support uplink communications on the second radio frequency spectrum band; and
the first capability configuration supports uplink communications on the first radio frequency spectrum band and the second radio frequency spectrum band.

21. The apparatus of claim 13, wherein the uplink communications on the first radio frequency spectrum band and the second radio frequency spectrum band comprise uplink carrier aggregation communications.

22. The apparatus of claim 13, wherein the one or more instructions are further executable by the processor to:
employ the first antenna as a primary receive antenna for the first radio frequency spectrum band and the second antenna as a diversity receive antenna for the first radio frequency spectrum band before coupling the second transceiver to the first antenna and switching the first transceiver to the second antenna; and
employ the first antenna as a primary receive antenna for the first radio frequency spectrum band and the second antenna as a diversity receive antenna for the first radio frequency spectrum band after coupling the second transceiver to the first antenna and switching the first transceiver to the second antenna.

23. The apparatus of claim 13, wherein the one or more instructions are further executable by the processor to:
employ the first antenna and the first transceiver as a primary communication chain when uplink communications on the first radio frequency spectrum band are used.

24. A non-transitory computer readable medium storing code for wireless communication, the code comprising one or more instructions executable by a processor to:
perform uplink communications on a first radio frequency spectrum band using a first transceiver and a first antenna, the first transceiver having a first capability configuration;
receive an assignment for uplink communications on a second radio frequency spectrum band;
couple a second transceiver to the first antenna so as to perform the uplink communications on the first radio frequency spectrum band using the second transceiver and the first antenna, the second transceiver having a second capability configuration that is different from the first capability configuration with respect to at least the second radio frequency spectrum band; and
switch the first transceiver to a second antenna for the uplink communications on the second radio frequency spectrum band.

25. The non-transitory computer readable medium of claim 24, wherein the one or more instructions executable by the processor to couple the second transceiver to the first antenna comprise one or more instructions executable by the processor to do at least one of:
use an antenna switch diversity function to couple the second transceiver to the first antenna, or switch the first transceiver to the second antenna including using an antenna switch diversity function to switch the first transceiver to the second antenna.

26. The non-transitory computer readable medium of claim 24, wherein the second capability configuration does not support uplink communications on the second radio frequency spectrum band and the first capability configuration supports uplink communications on the first radio frequency spectrum band and the second radio frequency spectrum band.

27. The non-transitory computer readable medium of claim 24, wherein the one or more instructions executable by the processor to couple the second transceiver to the first antenna comprise one or more instructions executable by the processor to:
couple the second transceiver to the first antenna during an active session of the uplink communications on the first radio frequency spectrum band.

28. The non-transitory computer readable medium of claim 24, wherein the instructions are further executable by the processor to:
identify a difference between the first capability configuration and the second capability configuration; and
adjust at least one parameter associated with the second transceiver based at least in part on the difference.

29. The non-transitory computer readable medium of claim 28, wherein the at least one parameter comprises at least one of an output power of the second transceiver, an output frequency of the second transceiver, an output timing parameter of the second transceiver, or an output data rate of the second transceiver.

30. The non-transitory computer readable medium of claim 28, wherein the one or more instructions executable by the processor to adjust the at least one parameter comprise one or more instructions executable by the processor to:
adjust the at least one parameter of the second transceiver to provide an input to the first antenna that is substantially the same as an input to the first antenna provided by the first transceiver.
